(19) United States
(12) Patent Application Publication
(10) Pub. No.: US 2017/0136764 A1
(43) Pub. Date: May 18, 2017

(54) PORTABLE PRINTER FOR PRINTING ON A STATIONARY MEDIA

(71) Applicant: FUNAI ELECTRIC CO., LTD., Osaka (JP)

(72) Inventors: Sam Norasak, Lexington, KY (US); Michael A. Marra, III, Lexington, KY (US); Bruce A. Deboard, Georgetown, KY (US)

(21) Appl. No.: 14/943,596

(22) Filed: Nov. 17, 2015

(51) Int. Cl. B41J 2/045

(52) U.S. Cl. CPC B41J 2/04505; B41J 2/04586

(57) ABSTRACT

A portable large format inkjet printer for printing an image at a media print area of a stationary flat media includes an inkjet print engine having a printhead carrier system configured to dynamically scan an inkjet printhead over the media print area in each of two orthogonal directions during the printing of the image. An alignment frame is configured to fixedly mount the inkjet print engine to facilitate a manual positioning of the alignment frame and the inkjet print engine in unison. The alignment frame has an open interior window within which the inkjet printhead is moved and from which all printing occurs. At least one alignment panel is mounted to the alignment frame. Each respective alignment panel has an alignment indicia configured to facilitate accurate manual positioning of the portable large format inkjet printer at a desired printing position at the media print area.

### CROSS-REFERENCE TO RELATED APPLICATIONS

None.

### BACKGROUND OF THE INVENTION

1. Field of the Invention

The present invention relates to large format printers, and, more particularly, to a portable large format printer for printing on a stationary flat media.

2. Description of the Related Art

Present large format printers are very large, heavy, and cumbersome, and are not intended to be portable. Typically, such prior large format printers are not readily movable after initial installation at a printing site, and thus are not considered to be portable. Also, such prior large format printers are relatively expensive to purchase. Additionally, such prior large format printers do not provide a good solution for printing on a large stationary surface, such as for example, a floor.

What is needed in the art is a portable large format printer for printing on a stationary flat media, wherein the portable large format printer is easy to move and manipulate, and can be provided to a consumer at a lower cost.

### SUMMARY OF THE INVENTION

The present invention provides a relatively low cost, truly portable, large format printer for printing directly on any printable media having a stationary flat surface, such as a flat surface formed of cement, brick, wood, laminated surfaces, stone, marble, carpet, fabric, etc. Such surfaces may be, for example, in the form of a floor, wall, ceiling, countertop, patio, driveway, walkway, sidewalk, etc. Images may be printed on a media print area that is larger than the resident print area of the printer by dividing the media print area into a plurality of sectional print zone grids, and then manually positioning and aligning the printer at each sectional print zone grid to individually print each sectional print zone grid that forms the media print area. Further, the functionality of the portable large format printer of the present invention may be minimized to just that required to satisfy basic printing requirements, so as to further lower the cost to the consumer.

As used herein, the term “printable media” means a substrate having a surface capable of accepting, absorbing, and/or adhering to ink jetted onto the surface and allowed to dry. The term “flat surface” refers to a generally planar surface, which may be entirely smooth, entirely non-smooth, or a combination of smooth and non-smooth surface portions. A non-smooth surface is a surface that includes surface irregularities, such as dips, rises, indentations, pores, cracks, surface offsets, etc. The term “generally planar surface” is a surface wherein a curvature deviation from planar is within a range of ±2 inches (approximately ±6 centimeters) over a span of 4 feet (1.22 meters), and wherein the surface may have surface deviations from planar in a range of ±2 inches (approximately ±6 centimeters).

The invention in one form is directed to a portable large format inkjet printer for printing a media print area of a stationary flat media. A controller is configured to execute program instructions to facilitate printing of an image in the media print area. An inkjet print engine has a printhead carrier system, an inkjet printhead, and an ink reservoir in fluid communication with the inkjet printhead. The printhead carrier system is configured to carry the inkjet printhead over the media print area in each of two orthogonal directions during the printing of the image. Each of the printhead carrier system and the inkjet printhead is communicatively coupled to the controller. The controller is configured to execute program instructions to control operation of each of the printhead carrier system and the inkjet printhead in printing the image at the media print area. An alignment frame is configured to fixedly mount the inkjet print engine to facilitate a manual positioning of the alignment frame and the inkjet print engine in unison. The alignment frame has an open interior window within which the inkjet printhead is moved and from which all printing occurs. At least one alignment panel is mounted to the alignment frame. Each respective alignment panel has an alignment indicia configured to facilitate accurate manual positioning of the portable large format inkjet printer at a desired printing position at the media print area.

The invention in another form is directed to a portable large format inkjet printer for printing a media print area of a flat media. A controller is configured to execute program instructions to facilitate printing of an image in the media print area. An inkjet print engine has a printhead carrier system, at least one inkjet printhead, and at least one ink reservoir in fluid communication with the at least one inkjet printhead. The printhead carrier system is configured to scan the at least one inkjet printhead relative to the media print area in each of two orthogonal directions during the printing of the image. Each of the printhead carrier system and the at least one inkjet printhead is communicatively coupled to the controller. The controller is configured to execute program instructions to control operation of each of the printhead carrier system and the at least one inkjet printhead in printing the image at the media print area. An alignment frame is configured to fixedly mount the inkjet print engine to facilitate a manual positioning of the alignment frame and the inkjet print engine in unison. The alignment frame has an open interior window within which the at least one inkjet printhead is moved and from which all printing occurs. A vertical printing adapter is connected to the alignment frame. The vertical printing adapter has a first longitudinal strut having opposed free ends. A pair of legs is spaced apart along the length of the first longitudinal strut. Each of the pair of legs is configured to provide releasable attachment to the flat media. A second longitudinal strut has opposed free ends. A pair of legs is spaced apart along the length of the second longitudinal strut. Each of the pair of legs is configured to provide releasable attachment to the flat media. The second longitudinal strut is laterally spaced from the first longitudinal strut with the alignment frame being located between the first longitudinal strut and the second longitudinal strut. A first lateral strut is slidably connected to each of the first longitudinal strut and the second longitudinal strut. The first lateral strut is slidably connected to the alignment frame at two spaced locations. A second lateral strut is slidably connected to each of the first longitudinal strut and the second longitudinal strut. The second lateral strut is longitudinally spaced from the first lateral strut. The second lateral strut is slidably connected to the alignment frame at two spaced locations.

The invention in another form is directed to a method for printing an image at a media print area of a stationary flat media. The method includes providing a portable large format inkjet printer having an inkjet print engine having a printhead carrier system that carries a plurality of inkjet printheads over the media print area in each of two orthogonal directions during the printing of the image, having an alignment frame having an open interior window within which the plurality of inkjet printheads are moved and from which all printing occurs, and having at least one alignment panel mounted to the alignment frame, each respective alignment panel having an alignment indicia located within a field of view of the open interior window; providing a mark on the stationary flat media to identify a desired printing position at the media print area; manually positioning the portable large format inkjet printer to align the alignment indicia with the mark on the stationary flat media; and operating the portable large format inkjet printer to print at least a portion of the image at the media print area of the stationary flat media.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a top view of a portable large format inkjet printer in accordance with the present invention.

FIG. 2 is a side view of the portable large format inkjet printer of FIG. 1.

FIG. 3 is a perspective view of the portable large format inkjet printer of FIG. 1.

FIG. 4 is a general electrical block diagram of the portable large format inkjet printer of FIG. 1.

FIG. 5 is a diagrammatic representation of the printhead carrier system of the inkjet print engine of the portable large format inkjet printer of FIGS. 1 and 4.

FIG. 6 is a top view of the portable large format inkjet printer of FIG. 1, wherein the printhead carrier system depicted in FIG. 5 has been removed to more clearly see the alignment frame.

FIG. 7 is a top view of a single transparent alignment panel configured to be mounted to the alignment frame and cover an entirety of an open interior window defined by the alignment frame.

FIG. 8 is an example of an image for printing at a media print area of a stationary flat media.

FIG. 9 is a graphical depiction of a method of printing the image of FIG. 8 at a media print area of a stationary flat media, wherein the resident print area of the portable large format inkjet printer of FIG. 1 is smaller than the media print area of a stationary flat media.

FIG. 10 is a top view of another embodiment, wherein the portable large format inkjet printer of FIG. 1 is adapted for printing on a vertically oriented flat media.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

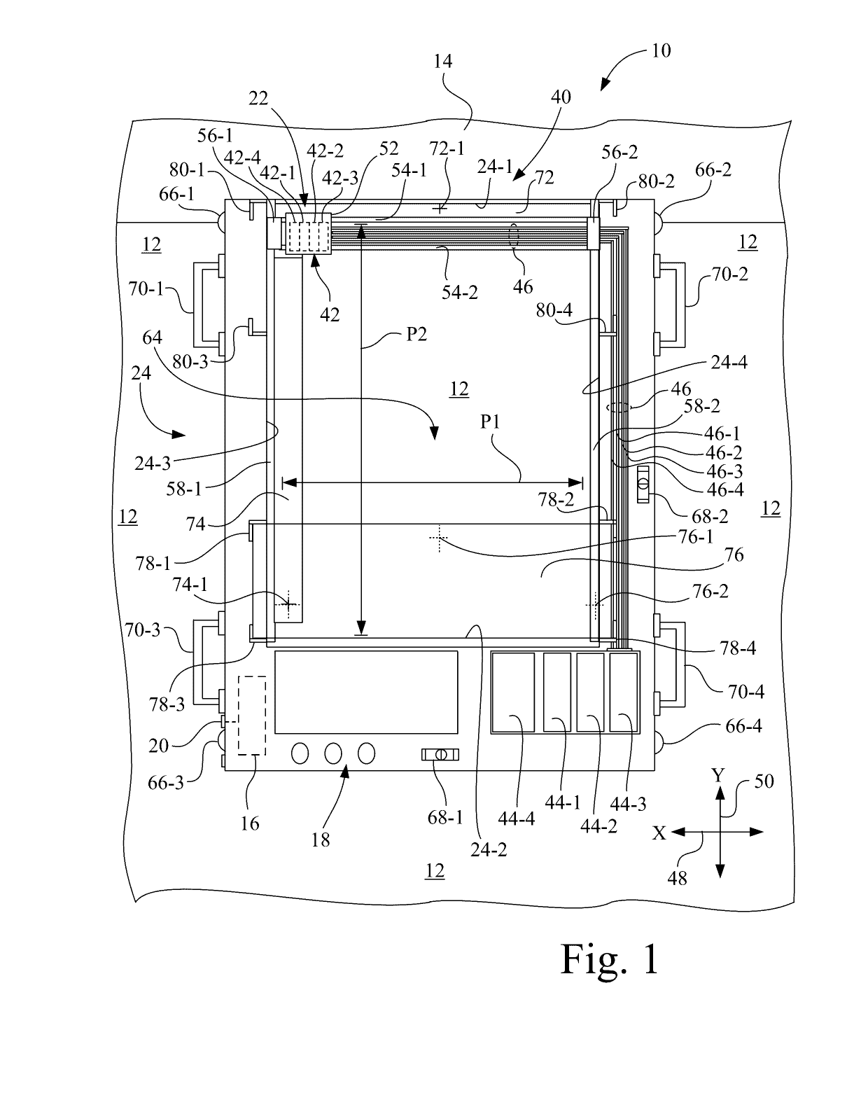

Referring now to the drawings, and more particularly to FIGS. 1-3, there is shown a portable large format inkjet printer 10 for printing a media print area 12 of a stationary flat media 14. Examples of such stationary flat media include, for example, a floor, a wall, a ceiling, a countertop, a patio, a driveway, a walkway, a sidewalk, etc., with a flat surface of which that may be formed by a variety of materials, such as, for example, cement, brick, wood, laminated materials, stone, marble, carpet, fabric, etc. In accordance with the present invention, inkjet printer 10 is configured to accommodate any size of media print area 12 of stationary flat media 14, e.g., the size of size of media print area 12 may be tens or hundreds of times larger than that of a resident print area of portable large format inkjet printer 10.

Portable large format inkjet printer 10 includes a controller 16, a user interface 18, an image data input interface 20, and an inkjet print engine 22, and an alignment frame 24.

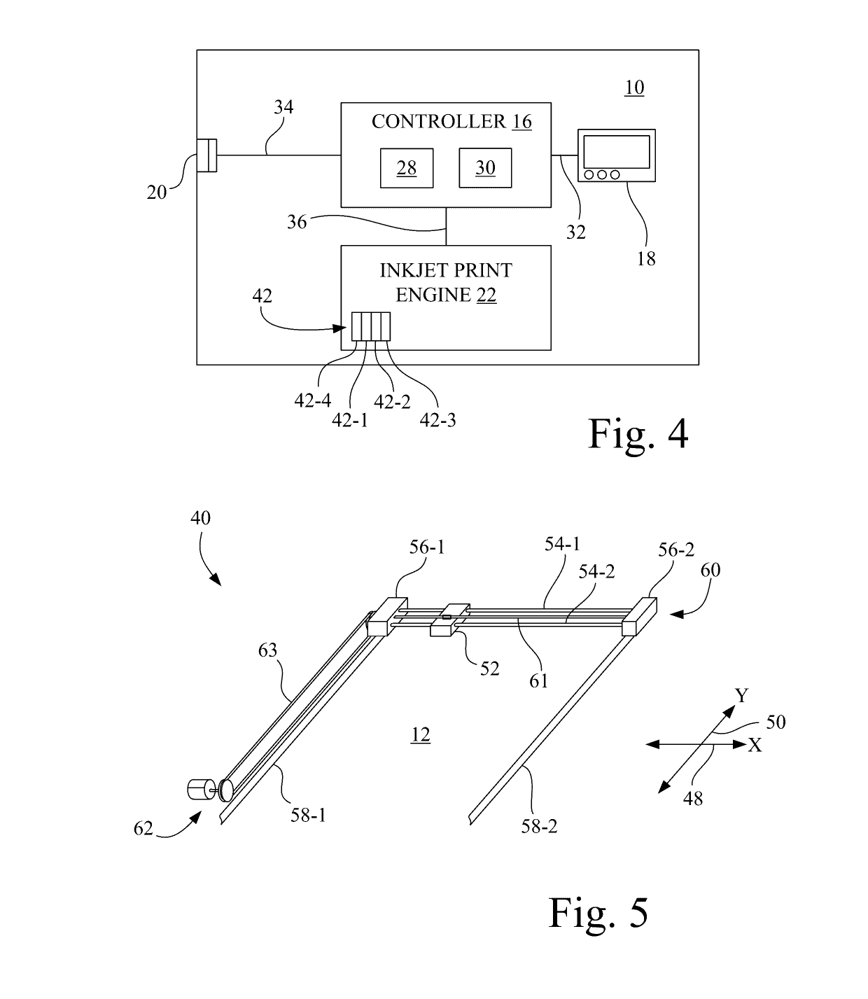

Referring also to FIG. 4, controller 16 is configured to execute program instructions to facilitate printing of an image, such as an image 26 depicted in FIG. 8, in media print area 12. Controller 16 includes a processor circuit 28 and a memory circuit 30, and may be formed as one or more Application Specific Integrated Circuits (ASIC). Processor circuit 28 of controller 16 is configured via software and/or firmware to operate as a printer controller for performing printing functions, as well as to process user input from, for example, user interface 18 and image data input interface 20.

Processor circuit 28 has one or more programmable microprocessors and associated circuitry, such as an input/output interface, clock, buffers, memory, etc. Memory circuit 30 is communicatively coupled to processor circuit 28, e.g., via a bus circuit, and may include volatile memory circuits, such as random access memory (RAM), and non-volatile memory circuits, such as read only memory (ROM), electronically erasable programmable ROM (EEPROM), NOR flash memory, NAND flash memory, etc.

Controller 16 is electrically connected and communicatively coupled to user interface 18 via a communications link 32, e.g., by wired connections. User interface 18 may be, for example, a touch screen display having a touch surface to facilitate user input, and a display to provide visual information to the user, and may include one or more pushbutton inputs (three shown).

Controller 16 is electrically connected and communicatively coupled to image data input interface 20 via a communications link 34, e.g., by wired connections, bus structure, etc. Image data input interface 20 is configured to receive image data from a user, wherein the image data may be supplied in a wired or wireless fashion. For example, image data input interface 20 may include, for example, a USB port for directly connecting to a computing device, such as a personal computer, or for connecting to a portable memory device, such as a thumb drive having electronic memory. Also, image data input interface 20 may include an Ethernet port for connection to a local area network. Image data input interface 20 may further be configured to directly receive a miniature memory card, such as an SD memory card. Still further, image data input interface 20 may be configured to facilitate wireless communication, e.g., via Bluetooth or IEEE 802.11. Controller 16 executes program instructions to process image data received by image data input interface 20, and to convert (e.g., format, halftone, etc.) the received image data into a data format compatible with inkjet print engine 22 for printing the image represented by the image data at media print area 12 of stationary flat media 14.

Controller 16 is electrically connected and communicatively coupled to inkjet print engine 22 via a communications link 36, such as for example, one or more multi-conductor interface cables. Controller 16 executes program instructions to process print commands, to process image data (e.g., by performing data formatting, half-toning, etc.), and to operate inkjet print engine 22 during a printing operation, to form a printed image at media print area 12 of a stationary flat media 14.

Inkjet print engine 22 has a printhead carrier system 40, a plurality of inkjet printheads 42 (individually 42-1, 42-2, 42-3, and 42-4), and a corresponding plurality of ink reservoirs 44 in fluid communication with the plurality of inkjet printheads 42. In the present embodiment, each of the plurality of inkjet printheads 42 include an associated nozzle array and associated firing heaters, and are coupled in fluid communication with the plurality of ink reservoirs 44 via a corresponding plurality of flexible conduits 46, e.g., rubber tubes.

In the present embodiment, the plurality of ink reservoirs 44 are located off-carrier, i.e., not transported by printhead carrier system 40. The plurality of ink reservoirs 44 may include a cyan ink reservoir 44-1, a magenta ink reservoir 44-2, a yellow ink reservoir 44-3 and a black ink reservoir 44-4. Cyan ink reservoir 44-1 is coupled in fluid communication with inkjet printhead 42-1 via a flexible conduit 46-1. Magenta ink reservoir 44-2 is coupled in fluid communication with inkjet printhead 42-2 via a flexible conduit 46-2. Yellow ink reservoir 44-3 is coupled in fluid communication with inkjet printhead 42-3 via a flexible conduit 46-3. Black ink reservoir 44-4 is coupled in fluid communication with inkjet printhead 42-4 via a flexible conduit 46-4. Alternatively, each of the respective ink reservoir/inkjet printhead combinations may be formed as a unitary inkjet printhead cartridge.

Referring also to FIG. 5, printhead carrier system 40 is configured to carry, i.e., scan, the plurality of inkjet printheads 42 over media print area 12 in each of two orthogonal directions (e.g., bidirectional X-direction 48 and bi-directional Y-direction 50) during the printing of the image, e.g., image 26. Each of the printhead carrier system 40 and the plurality of inkjet printheads 42 is communicatively coupled to the controller 16 via communications link 36. Controller 16 is configured to execute program instructions to control operation of each of the printhead carrier system 40 and each of the plurality of inkjet printheads 42 in printing the image at media print area 12.

Printhead carrier system 40 includes a printhead carrier 52 for mounting and carrying the plurality of inkjet printheads 42. Printhead carrier system 40, including printhead carrier 52 and the plurality of inkjet printheads 42, is configured to define a first printing extent P1 (see also FIG. 1) in the bidirectional X-direction 48 and a second printing extent P2 in bi-directional Y-direction 50, wherein the dimensions of the first printing extent P1 and the second printing extent P2 define a resident print area P1×P2 of portable large format inkjet printer 10.

As shown in FIGS. 1 and 5, printhead carrier 52 is suspended above media print area 12 for movement in X-direction 48 by a pair of lateral guide members 54-1, 54-2 mounted to, and which extend laterally in X-direction 48 between, two spaced slide blocks 56-1, 56-2. The two spaced slide blocks 56-1, 56-2 are respectively slidably supported for movement in Y-direction 50 by a pair of spaced longitudinal guide members 58-1, 58-2. Each of lateral guide members 54-1, 54-2 and each of longitudinal guide members 58-1, 58-2 may be, for example, a guide rod or a guide rail.

Lateral movement of printhead carrier 52 along X-direction 48 may be effected by a lateral scan mechanism 60, such as a motor driven belt/pulley arrangement having a translation drive belt 61 attached to printhead carrier 52, wherein lateral guide members 54-1, 54-2 define a lateral scanning path of the printhead carrier 52 and the plurality of inkjet printheads 42 along X-direction 48. Based on program instructions executed by controller 16, controller 16 operates lateral scan mechanism 60 to dynamically scan the plurality of inkjet printheads 42 along the lateral scanning path during each of a plurality of lateral printing passes of the plurality of inkjet printheads 42 over media print area 12. The term “lateral” with respect to the scanning path and the printing passes may sometimes also be referred to in the art as a “horizontal” scan path and “horizontal” print passes.

Longitudinal movement of printhead carrier 52 along Y-direction 50 may be effected by a longitudinal scan mechanism 62, such as a motor driven belt/pulley arrangement having a translation drive belt 63 attached to lateral scan mechanism 60, wherein longitudinal guide members 58-1, 58-2 define a longitudinal scanning path of the lateral scan mechanism 60 along Y-direction 50, and in turn, the longitudinal scanning path of printhead carrier 52 and the plurality of inkjet printheads 42 along Y-direction 50. Based on program instructions executed by controller 16, controller 16 operates longitudinal scan mechanism 62 to longitudinally position lateral scan mechanism 60, and in turn, to move printhead carrier 52 and the plurality of inkjet printheads 42, along the longitudinal scan path. The longitudinal scan path sometimes is also referred to in the art as a “vertical” scan path.

The longitudinal scan path is defined by a plurality of discrete longitudinally spaced (i.e., in Y-direction 50) lateral scan positions, and longitudinal scan mechanism 62 is configured to sequentially position lateral scan mechanism 60, and in turn, printhead carrier 52 and the plurality of inkjet printheads 42, at a selected one of the plurality of discrete longitudinally spaced lateral scan positions during each lateral printing pass of printhead carrier 52 and the plurality of inkjet printheads 42 over media print area 12 of stationary flat media 14.

Thus, controller 16 executes program instructions to control the operation of lateral scan mechanism 60 and longitudinal scan mechanism 62 to carry and dynamically scan the plurality of inkjet printheads 42 over media print area 12 in each of the two orthogonal directions (e.g., X-direction 48 and Y-direction 50), while also controlling the operation (i.e., ink jetting) of the plurality of inkjet printheads 42, during the printing of the image, e.g., image 26 of FIG. 8.

Referring again to FIG. 1, alignment frame 24 is configured to fixedly mount the inkjet print engine 22 to facilitate a manual positioning of the alignment frame 24 and the inkjet print engine 22 in unison at the media print area 12. In particular, longitudinal guide members 58-1, 58-2 of printhead carrier system 40 of inkjet print engine 22 are fixedly mounted, e.g., by fasteners, such as bolts, screws, welds, adhesive, etc., to alignment frame 24.

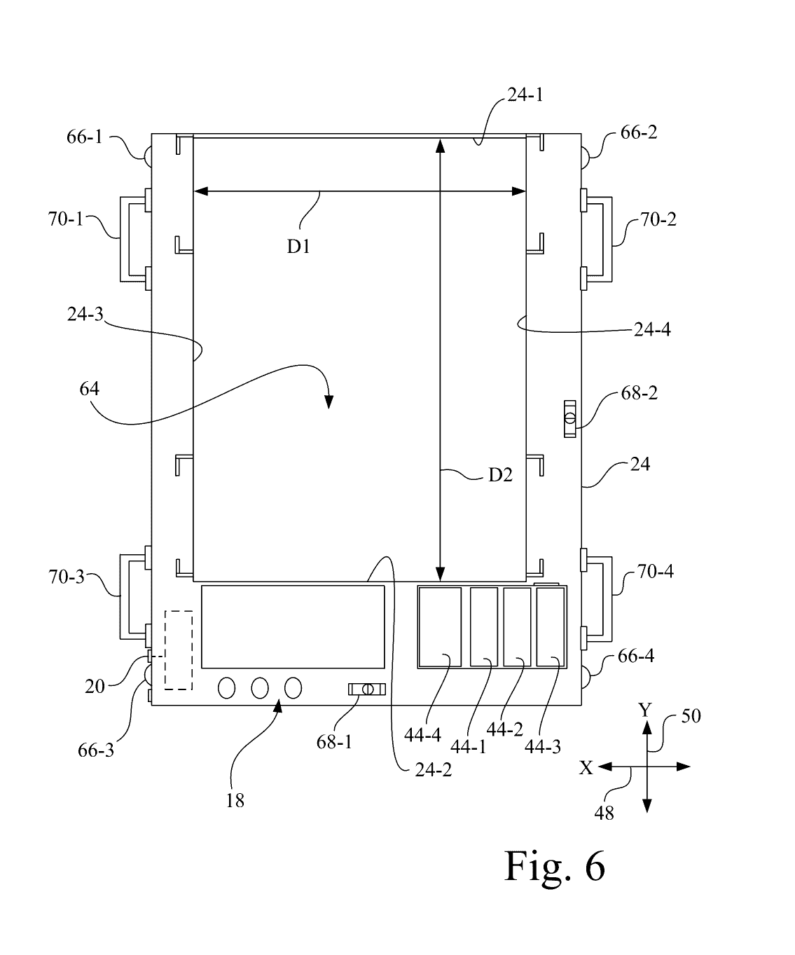

Referring also to FIG. 6, alignment frame 24 of the portable large format inkjet printer 10 is shown with printhead carrier system 40 having been removed to aid in the understanding of the configuration of alignment frame 24. Alignment frame 24 is configured with an open frame architecture having an open interior window 64, e.g., rectangular, within which printhead carrier 52 and the plurality of inkjet printheads 42 are moved, and from which all printing occurs. (See also FIG. 1). Open interior window 64 is defined by lateral side walls 24-1, 24-2 and longitudinal side walls 24-3, 24-4. Longitudinal side wall 24-3 is spaced from longitudinal side wall 24-4 by a lateral distance D1 in X-direction 48, wherein longitudinal side walls 24-3, 24-4 are substantially parallel. Lateral side wall 24-1 is spaced from lateral side wall 24-2 by a longitudinal distance D2 in Y-direction 50, wherein lateral side walls 24-1, 24-2 are substantially parallel. As used herein, the term “substantially parallel” means parallel or a deviation from parallel within a range of ±2 degrees. Referring also to FIG. 5, longitudinal guide members 58-1, 58-2 of printhead carrier system 40 of inkjet print engine 22 are fixedly mounted, e.g., by fasteners, such as bolts, screws, welds, adhesive, etc., to longitudinal side walls 24-3, 24-4 of alignment frame 24.

The open area of open interior window 64 of alignment frame 24 having dimensions D1×D2 is referred to herein as the field-of-view of alignment frame 24. By way of example only, the length of dimension D1 may be in a range of two to three feet (0.61 to 0.91 meters), and the length of dimension D2 may be in a range of three to four feet (0.91 to 1.22 meters). In the present embodiment, the field-of-view D1×D2 of alignment frame 24 is slightly larger than the resident print area P1×P2 of portable large format inkjet printer 10. As used herein, the term “slightly larger” means in a range of 0.5 percent to 10.0 percent larger.

Referring again to FIGS. 1-3 and 6, portable large format inkjet printer 10 has a set of four legs 66-1, 66-2, 66-3, 66-4, with each being respectively attached to alignment frame 24 near one of the four corners of alignment frame 24. Each of the plurality of legs 66-1, 66-2, 66-3, 66-4 has a free end configured to contact the stationary flat media 14 to space inkjet print engine 22 away from media print area 12. At least one of the plurality of legs 66-1, 66-2, 66-3, 66-4, is configured as a screw-type height adjuster, such as that used to level furniture, so as to permit compensation for an irregular surface of stationary flat media 14, such that portable large format inkjet printer 10 is level relative to the lateral and longitudinal extent of media print area 12 of stationary flat media 14.

To aid in leveling portable large format inkjet printer 10 relative to stationary flat media 14, attached to alignment frame 24 is a pair of bubble levels 68-1, 68-2.

Also, to aid in the manual positioning of portable large format inkjet printer 10 relative to media print area 12 of stationary flat media 14, portable large format inkjet printer 10 includes a set of side handles 70-1, 70-2, 70-3, and 70-4, with each being respectively attached to a side wall of alignment frame 24 near one of the four corners of alignment frame 24. Side handles 70-1, 70-2, 70-3, and 70-4 are configured to be grasped by one or more users in positioning portable large format inkjet printer 10 relative to media print area 12 of stationary flat media 14.

Referring again to FIG. 1, portable large format inkjet printer 10 has at least one alignment panel mounted to alignment frame 24, and positioned within the field-of-view of alignment frame 24 in open interior window 64. In the embodiment shown in FIG. 1, there is shown three alignment panels, namely: an alignment panel 72, an alignment panel 74, and an alignment panel 76. Each of alignment panel 72, alignment panel 74, and alignment panel 76 may be formed from a transparent plastic, e.g., plate, material and are rectangular in shape. Each respective alignment panel 72, 74, 76 has an alignment indicia configured to facilitate accurate manual positioning of the portable large format inkjet printer 10 at a desired printing position at media print area 12.

Alignment panel 72 is mounted to, and adjacent, lateral side wall 24-1 of alignment frame 24. Alignment panel 72 has an alignment indicia 72-1 that is offset from an interior edge of alignment panel 72, which in the present embodiment, is in the form of a symbol, e.g., a cross, located in a central portion (along the X-direction 48) of alignment panel 72. Alignment indicia 72-1 is located at a respective fixed position within the field-of-view of open interior window 64 of alignment frame 24.

Alignment panel 74 is mounted to, and adjacent, longitudinal side wall 24-3 of alignment frame 24. Alignment panel 74 has an alignment indicia 74-1 that is offset from an interior edge of alignment panel 74, which in the present embodiment, is in the form of a symbol, e.g., a cross, located in a proximal end portion of longitudinal side wall 24-3. Alignment indicia 74-1 is located at a respective fixed position within the field-of-view of open interior window 64 of alignment frame 24.

Alignment indicia 72-1 is offset, in a rectilinear sense, from alignment indicia 74-1 in both the X-direction 48 and the Y-direction 50, and thus collectively, alignment indicia 72-1 and alignment indicia 74-1 may be used to align alignment frame 24, and in turn the entirety of portable large format inkjet printer 10, at the desired lateral, longitudinal, and rotational orientation with respect to media print area 12 to achieve a desired printing position at media print area 12 of stationary flat media 14.

Alternatively, one or more of the orthogonal interior edges of alignment panel 72 and/or alignment panel 74, within a field-of-view D1×D2 of the open interior window 64 of alignment frame 24, may be used to facilitate accurate manual positioning of the portable large format inkjet printer 10 at the desired printing position at media print area 12.

Alignment panel 76 is mounted to, and is adjacent, lateral side wall 24-2 of alignment frame 24. Alignment panel 76 may be mounted to alignment frame 24 using a set of four bracket holders 78-1, 78-2, 78-3, 78-4. An alternative position for alignment panel 76 is defined by a second set of four bracket holders 80-1, 80-2, 80-3, 80-4. Alignment panel 76 has a pair of alignment indicia 76-1, 76-2. In the present embodiment, alignment indicia 76-1 is offset from an interior edge of alignment panel 76, and is in the form of a symbol, e.g., a cross, located in a central portion (along the X-direction 48) of alignment panel 76. Alignment indicia 76-2 is offset from an interior edge of alignment panel 72, and is in the form of a cross located near a right lower corner of alignment panel 76. Each of alignment indicia 76-1 and alignment indicia 76-2 is located at a respective fixed position within a field-of-view of open interior window 64 of alignment frame 24. Alignment indicia 76-1 is offset, in a rectilinear sense, from alignment indicia 76-2 in both the X-direction 48 and the Y-direction 50.

Alignment panel 76 may be used to supplement alignment indicia 72-1 and/or alignment indicia 74-1, or alternatively, may be used instead of alignment indicia 72-1 and/or alignment indicia 74-1. Thus, alignment indicia 76-1 and alignment indicia 76-2 may be used to align alignment frame 24, and in turn the entirety of portable large format inkjet printer 10, at the desired lateral, longitudinal, and rotational orientation with respect to media print area 12 to achieve a desired printing position at media print area 12 of stationary flat media 14.

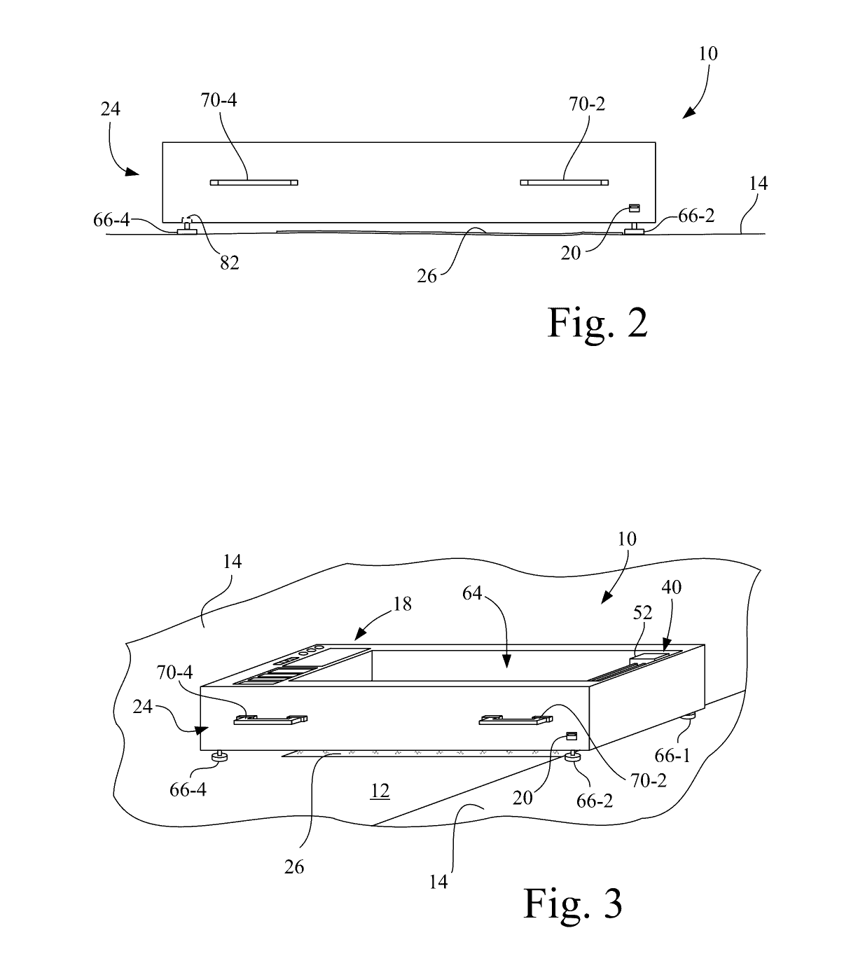

Portable large format inkjet printer 10 may include a supplemental fine adjustment mechanism 82 (see FIG. 2), such as a set of horizontal screw devices, to aid in making a fine adjustment of the orientation of align alignment frame 24 with media print area 12 of stationary flat media 14. Such fine adjustment mechanism may be, for example, interposed between each of the plurality of legs 66-1, 66-2, 66-3, 66-4 and alignment frame 24 to aid in making final fine lateral, longitudinal, and/or rotational adjustments of portable large format inkjet printer 10 relative to media print area 12 of stationary flat media 14.

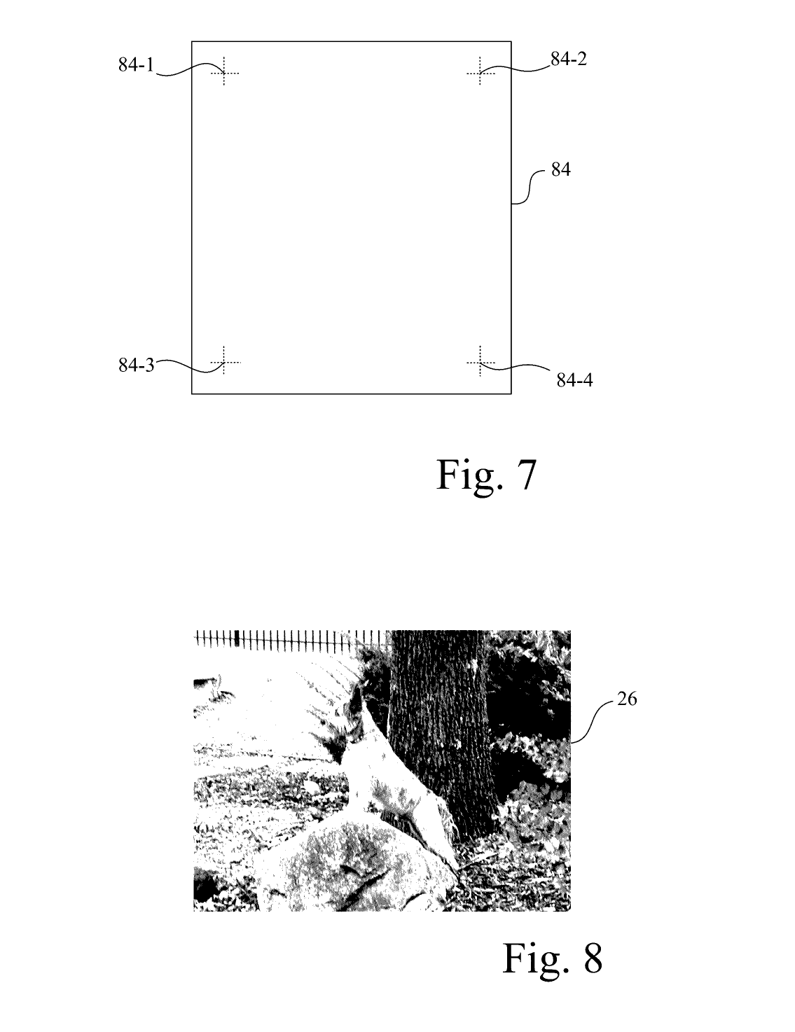

Referring now to FIG. 7, as an alternative to using one or more of alignment panels 72, 74, 76, there is shown a single transparent alignment panel 84, which may be mounted to alignment frame 24 to cover an entirety of open interior window 64 of the alignment frame 24, wherein the plurality of inkjet printheads 42 are interposed between alignment panel 84 and media print area 12. Alignment panel 84 will have at least two alignment indicia, and preferably four alignment indicia 84-1, 84-2, 84-3, 84-4, located within the field-of-view of open interior window 64 of alignment frame 24, and each located in a respective corner portion of alignment panel 84. Each of alignment indicia 84-1, 84-2, 84-3, 84-4 is in the form of a symbol, e.g., a cross. Referring again to FIG. 1, alignment panel 84 is mounted to alignment frame 24 using bracket holders 80-1, 80-2 and 78-3, 78-4.

The operation of portable large format inkjet printer 10 will now be described in printing image 26 of FIG. 8 on media print area 12 of stationary flat media 14.

If the resident print area P1×P2 of portable large format inkjet printer 10 is greater than or equal to media print area 12, portable large format inkjet printer 10 is manually positioned and aligned at media print area 12. Then, controller 16 will execute program instructions to process the image data representing image 26 to size image 26 to fit within media print area 12. Thereafter, the controller 16 will execute program instructions to operate inkjet print engine 22 to print image 26 at media print area 12 of stationary flat media 14.

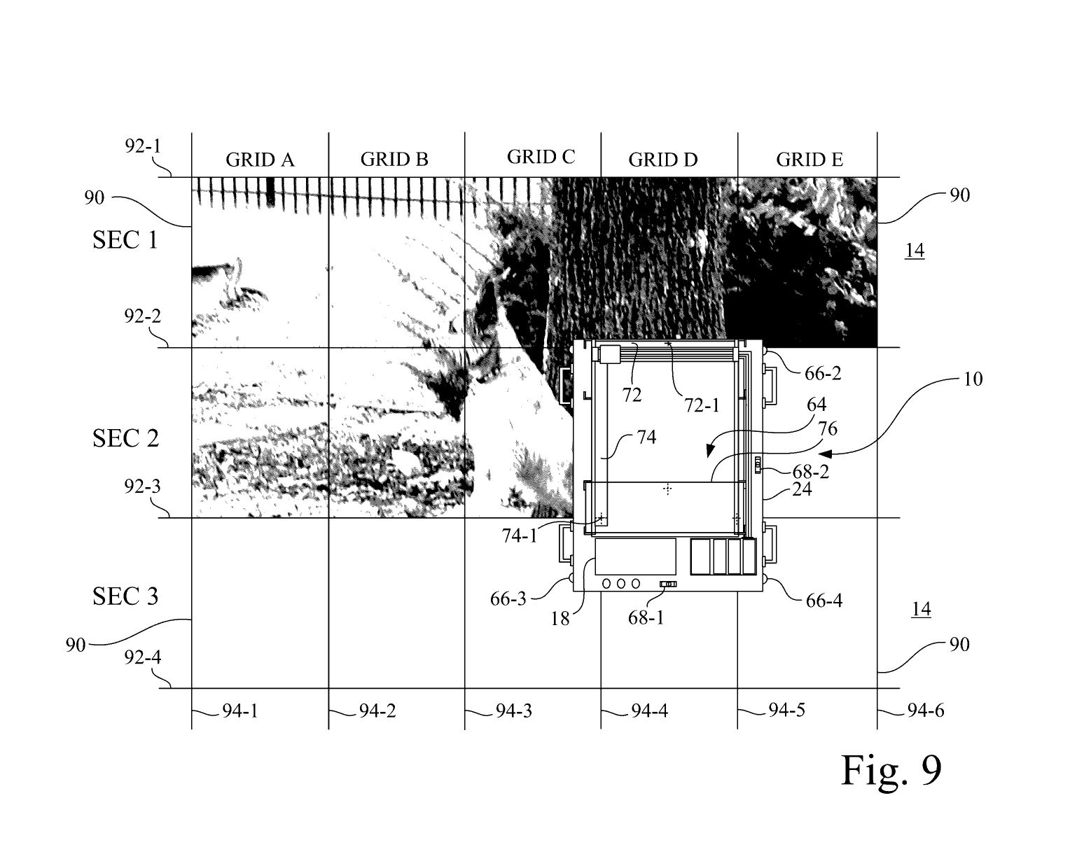

However, with reference to FIG. 9, in the event that the resident print area P1×P2 of portable large format inkjet printer 10 is smaller than the media print area, as in the media print area 90 of the imaging example of FIG. 9, then further manual positioning of portable large format inkjet printer 10 relative to media print area 90, and further processing of the image data representing image 26, is required.

In the example of FIG. 9, media print area 90 of stationary flat media 14 is physically divided into a matrix of areas by a plurality of section lines 92-1, 92-2, 92-3, 92-4, that orthogonally intersect a plurality of grid lines 94-1, 94-2, 94-3, 94-4, 94-5, 94-6, thereby forming a plurality of rows (sections) that intersect with a plurality of columns (grids) to define a plurality of sectional print zone grids, i.e., image portion areas, with the individual rows being identified in the present example as rows SEC1, SEC2, and SEC3, and with the individual columns being identified as GRID A, GRID B, GRID C, GRID D, and GRID E. The section lines 92-1, 92-2, 92-3, 92-4, and a plurality of grid lines 94-1, 94-2, 94-3, 94-4, 94-5, 94-6 may be physically formed on media print area 90 of stationary flat media 14, using chalk, graphite, or some other suitable marking material.

In addition, controller 16 executes program instructions to divide the image data representing image 26 into image data portions corresponding to the plurality of sectional print zone grids formed at the intersections of rows SEC1, SEC2, and SEC3, and columns GRID A, GRID B, GRID C, GRID D, and GRID E of media print area 90. Controller 16 further executes program instructions to control operation of the inkjet print engine 22 to print in sequence a respective image portion of image 26 at each sectional print zone grid of the plurality of sectional print zone grids, with portable large format inkjet printer 10 being manually relocated prior to the printing of a next image position.

More particularly, prior to printing, portable large format inkjet printer 10 is positioned and aligned at a first sectional print zone grid to be printed. If necessary, portable large format inkjet printer 10 may be leveled by adjusting the length of one or more of legs 66-1, 66-2, 66-3, 66-4. In this example, the first sectional print zone grid is at SEC1, GRID A. Portable large format inkjet printer 10 is positioned over sectional print zone grid SEC1, GRID A, and is aligned by positioning alignment frame 24 such that when the user looks through open interior window 64 toward stationary flat media 14, alignment indicia 72-1 intersects section line 92-1 and alignment indicia 74-1 intersects grid lines 94-1 of the pre-formed grid pattern.

The user now initiates a print start command at user interface 18, and controller 16 responds by executing program instructions to operate inkjet print engine 22 to print a corresponding image portion at sectional print zone grid SEC1, GRID A. Once the printing of the image portion at sectional print zone grid SEC1, GRID A is complete, then the user manually moves and positions portable large format inkjet printer 10 at a next sectional print zone grid to be printed, e.g., one of sectional print zone grid SEC2, GRID A or sectional print zone grid SEC1, GRID B adjacent sectional print zone grid SEC1, GRID A, and the alignment and printing process is repeated.

Thus, the alignment and printing process described above will be repeated until all of the plurality of sectional print zone grids is printed, and a full image corresponding to the image 26 of FIG. 8 is printed at the media print area 90 of stationary flat media 14 depicted in FIG. 9.

As an alternative to physically forming grid lines at the print media area 90, one or more interior edges of alignment panels 72, 74 may be used to align with a print edge of a previously printed image portion. As a further alternative, each previously printed image portion may include an alignment pattern, e.g., one or more symbols, such as a circle, dot, star, cross, etc., that is printed directly on print media area 90 near an image portion edge, and then used as a target for positioning alignment frame 24, wherein alignment frame 24 is manually manipulated until the appropriate alignment indicia is/are properly aligned with the printed alignment pattern.

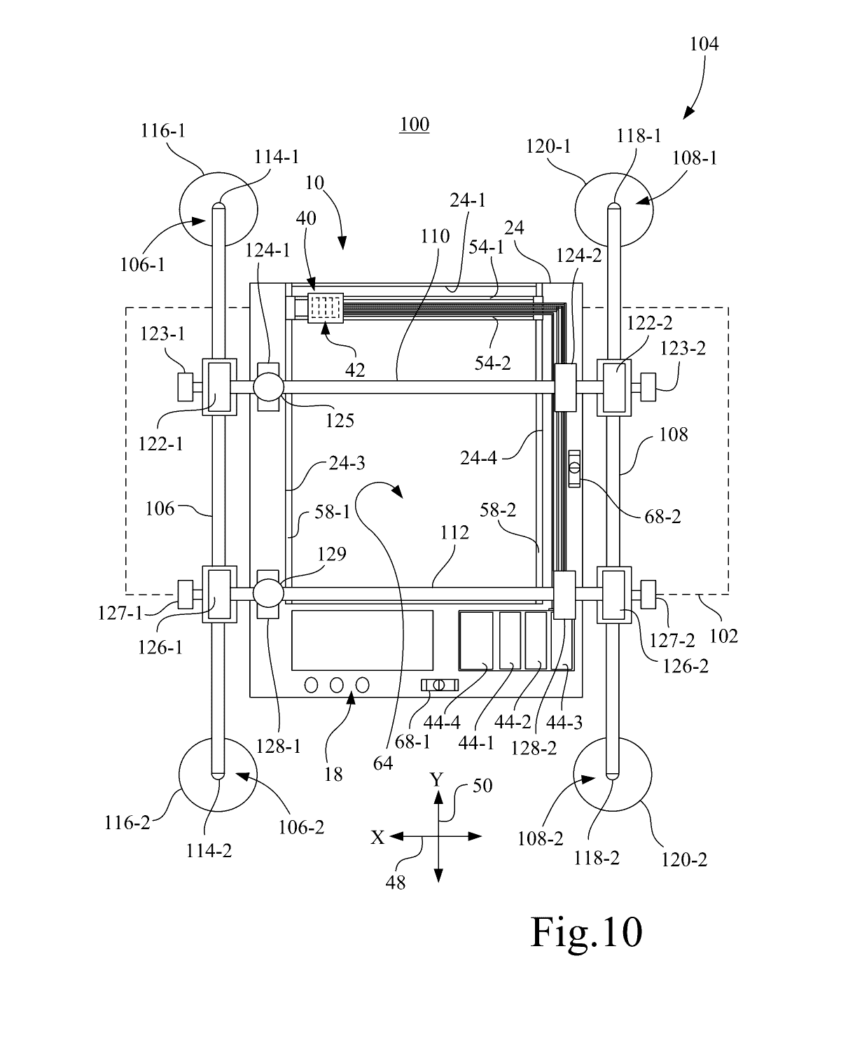

FIG. 10 shows another embodiment, wherein portable large format inkjet printer 10 is adapted for printing on a vertically oriented flat media 100, such as a wall, fence, retaining structure, shipping container, etc. As used herein, the term vertically oriented means a surface oriented at an angle in a range of 0 degrees to 65 degrees from vertical. However, it is to be understood that the portable large format inkjet printer 10 of the present embodiment may print on any stationary flat media surface oriented in a range of horizontal through vertical. Identified on vertically oriented flat media 100 is a media print area 102.

In summary, as discussed above, alignment frame 24 of portable large format inkjet printer 10 is configured to fixedly mount the inkjet print engine 22 to facilitate a manual movement of the alignment frame 24 and the inkjet print engine 22 in unison. Alignment frame 24 has an open interior window 64 within which the plurality of inkjet printheads 42 are moved and from which all printing occurs. Controller 16 is configured to execute program instructions to control operation of each of the printhead carrier system 40 and one or more of the plurality of inkjet printheads 42 in printing an image at a media print area, e.g., media print area 102 of vertically oriented flat media 100.

In accordance with the embodiment of FIG. 10, portable large format inkjet printer 10 is attached to a vertical printing adapter 104. In particular, vertical printing adapter 104 is connected to alignment frame 24 at multiple connection points.

Vertical printing adapter 104 has a first longitudinal strut 106, a second longitudinal strut 108, a first lateral strut 110, and a second lateral strut 112.

First longitudinal strut 106 has opposed free ends 106-1, 106-2. A pair of legs 114-1, 114-2 is connected to first longitudinal strut 106, and legs 114-1, 114-2 are spaced apart along the length of first longitudinal strut 106, e.g., at or near the opposed free ends 106-1, 106-2 of first longitudinal strut 106. Each of the pair of legs 114-1, 114-2 has a suction cup mount 116-1, 116-2 configured to provide releasable suction attachment to vertically oriented flat media 100.

Second longitudinal strut 108 has opposed free ends 108-1, 108-2. A pair of legs 118-1, 118-2 is connected to second longitudinal strut 108, and legs 118-1, 118-2 are spaced apart along the length of the second longitudinal strut 108, e.g., at or near the opposed free ends 108-1, 108-2 of second longitudinal strut 108. Each of the pair of legs 118-1, 118-2 has a suction cup mount 120-1, 120-2 configured to provide releasable suction attachment to vertically oriented flat media 100. Second longitudinal strut 108 is laterally spaced from first longitudinal strut 106 in X-direction 48, with the alignment frame 24 being located between first longitudinal strut 106 and second longitudinal strut 108.

As an alternative to suction cup mounts 116-1, 116-2, 120-1, 120-2, it is contemplated that other forms of releasable attachment to the vertically oriented flat media 100 may be provided, such as permanent magnet or electromagnetic mounts to facilitate magnetic attachment to a metallic surface, or mechanical fasteners, e.g., bolt, mounts to facilitate a temporary bolting attachment to a vertical surface, such as a wall.

First lateral strut 110 is slidably connected to each of first longitudinal strut 106 and second longitudinal strut 108 via a respective slide collar 122-1, 122-2. Each of slide collars 122-1, 122-2 has a hand screw with locking nut arrangement 123-1, 123-2 adapted to respectively engage first longitudinal strut 106 and second longitudinal strut 108 to releasably lock the position of first lateral strut 110 relative to first longitudinal strut 106 and second longitudinal strut 108 in Y-direction 50. First lateral strut 110 is slidably connected to alignment frame 24 at two spaced locations via slide collars 124-1, 124-2. At least one of slide collars 124-1, 124-2 has a hand screw with locking nut arrangement 125 adapted to respectively engage first lateral strut 110 to releasably lock the position of alignment frame 24 relative to first lateral strut 110 in X-direction 48.

Second lateral strut 112 is slidably connected to each of first longitudinal strut 106 and second longitudinal strut 108 via a respective slide collar 126-1, 126-2. Each of slide collars 126-1, 126-2 has a hand screw with locking nut arrangement 127-1, 127-2 adapted to respectively engage first longitudinal strut 106 and second longitudinal strut 108 to releasably lock the position of second lateral strut 112 relative to first longitudinal strut 106 and second longitudinal strut 108 in Y-direction 50. Second lateral strut 112 is slidably connected to alignment frame 24 at two spaced locations via slide collars 128-1, 128-2. At least one of slide collars 128-1, 128-2 has a hand screw with locking nut arrangement 129 adapted to respectively engage second lateral strut 112 to releasably lock the position of alignment frame 24 relative to second lateral strut 112 in X-direction 48.

Alignment of portable large format inkjet printer 10 using vertical printing adapter 104 may be accomplished using one or more of alignment panels 72, 74, 76, or single alignment panel 84, using the techniques described above. However, once vertical printing adapter 104 is attached to media print area 102 of vertically oriented flat media 100 via suction cup mounts 116-1, 116-2, 120-1, 120-2, any further lateral, longitudinal, or rotational positioning of portable large format inkjet printer 10 relative to media print area 102 at the present location is accomplished by sliding portable large format inkjet printer 10 along one or more of first longitudinal strut 106, second longitudinal strut 108, first lateral strut 110, and second lateral strut 112.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A portable large format inkjet printer for printing a media print area of a stationary flat media, comprising:
a controller configured to execute program instructions to facilitate printing of an image in the media print area;
an inkjet print engine having a printhead carrier system, an inkjet printhead, and an ink reservoir in fluid communication with the inkjet printhead, the printhead carrier system configured to carry the inkjet printhead over the media print area in each of two orthogonal directions during the printing of the image, wherein each of the printhead carrier system and the inkjet printhead is communicatively coupled to the controller, the controller configured to execute program instructions to control operation of each of the printhead carrier system and the inkjet printhead in printing the image at the media print area;
an alignment frame configured to fixedly mount the inkjet print engine to facilitate a manual positioning of the alignment frame and the inkjet print engine in unison, the alignment frame having an open interior window within which the inkjet printhead is moved and from which all printing occurs; and
at least one alignment panel mounted to the alignment frame, each respective alignment panel having an alignment indicia configured to facilitate accurate manual positioning of the portable large format inkjet printer at a desired printing position at the media print area.

2. The portable large format inkjet printer of claim 1, wherein the at least one alignment panel defines orthogonal edges within a field of view of the open interior window, the orthogonal edges configured to facilitate accurate manual positioning of the portable large format inkjet printer at the desired printing position at the media print area.

3. The portable large format inkjet printer of claim 1, wherein each of the at least one alignment panel is transparent and has at least one alignment indicia located at a respective fixed position within a field of view of the open interior window.

4. The portable large format inkjet printer of claim 1, wherein the at least one alignment panel comprises a plurality of alignment panels that are mounted to the alignment frame, wherein each alignment panel of the plurality of alignment panels is transparent and has at least one alignment indicia located at a respective fixed position that is offset from an interior edge of a respective alignment panel, and each alignment indicia being located within a field of view of the open interior window.

5. The portable large format inkjet printer of claim 1, wherein the at least one alignment panel comprises a single alignment panel mounted to the alignment frame that covers an entirety of the open interior window of the alignment frame, the single alignment panel being transparent and having at least two alignment indicia located within the field of view of the open interior window.

6. The portable large format inkjet printer of claim 1, comprising a plurality of legs mounted to the alignment frame, each of the plurality of legs having a free end configured to contact the stationary flat media to space the inkjet print engine away from the media print area, at least one of the plurality of legs having a height adjuster.

7. The portable large format inkjet printer of claim 1, comprising a plurality of legs mounted to the alignment frame, each of the plurality of legs having a free end with a suction cup mount configured to provide releasable suction attachment to the stationary flat media, the plurality of legs configured to space the inkjet print engine away from the media print area.

8. The portable large format inkjet printer of claim 1, wherein the printhead carrier is configured to carry a plurality of inkjet printheads, the inkjet printhead being one of the plurality of inkjet printheads, and having a plurality of ink reservoirs respectively in fluid communication with the plurality of inkjet printheads, the printhead carrier system configured to dynamically scan the plurality of inkjet printheads over the media print area in each of the two orthogonal directions during the printing of the image, wherein each of the plurality of inkjet printheads is communicatively coupled to the controller, the controller configured to execute program instructions to control operation of the printhead carrier system and each of the plurality of inkjet printheads in printing the image at the media print area.

9. The portable large format inkjet printer of claim 1, wherein the orthogonal directions have a first direction orthogonal to a second direction, the printhead carrier system configured to define a first printing extent in the first direction and a second printing extent in the second direction, wherein the dimensions of the first printing extent and the second printing extent define a resident print area of the portable large format inkjet printer, and
wherein the controller executes program instructions to process image data to print the image at the media print area, and if the resident print area is greater than or equal to the media print area, then the controller configured to execute program instructions to print the entirety of the image in the media print area after the portable large format inkjet printer is manually positioned and aligned at the media print area.

10. The portable large format inkjet printer of claim 1, wherein the orthogonal directions have a first direction orthogonal to a second direction, the printhead carrier system configured to define a first printing extent in the first direction and a second printing extent in the second direction, wherein the dimensions of the first printing extent and the second printing extent define a resident print area of the portable large format inkjet printer, and
wherein the controller executes program instructions to process image data to print the image at the media print area, and if the resident print area is smaller than the media print area, then the controller configured to execute program instructions to divide the media print area and corresponding image data into a plurality of sectional print zone grids, and to control operation of the inkjet print engine to print in sequence a respective image portion of the image at each sectional print zone grid of the plurality of sectional print zone grids, after the portable large format inkjet printer is manually positioned and aligned, respectively, at each sectional print zone grid of the media print area.

11. The portable large format inkjet printer of claim 1, wherein the alignment indicia of the portable large format inkjet printer is aligned with at least one edge of a previously printed image portion.

12. The portable large format inkjet printer of claim 1, wherein the media print area is marked with a pre-formed grid pattern formed by a plurality of intersecting grid markings, and wherein the alignment indicia of the portable large format inkjet printer is aligned with a pair of grid markings forming the pre-formed grid pattern.

13. A portable large format inkjet printer for printing a media print area of a flat media, comprising:
a controller configured to execute program instructions to facilitate printing of an image in the media print area;
an inkjet print engine having a printhead carrier system, at least one inkjet printhead, and at least one ink reservoir in fluid communication with the at least one inkjet printhead, the printhead carrier system configured to scan the at least one inkjet printhead relative to the media print area in each of two orthogonal directions during the printing of the image, wherein each of the printhead carrier system and the at least one inkjet printhead is communicatively coupled to the controller, the controller configured to execute program instructions to control operation of each of the printhead carrier system and the at least one inkjet printhead in printing the image at the media print area;
an alignment frame configured to fixedly mount the inkjet print engine to facilitate a manual positioning of the alignment frame and the inkjet print engine in unison, the alignment frame having an open interior window within which the at least one inkjet printhead is moved and from which all printing occurs; and
a vertical printing adapter connected to the alignment frame, the vertical printing adapter comprising:
a first longitudinal strut having opposed free ends, and having a pair of legs spaced apart along the length of the first longitudinal strut, each of the pair of legs configured to provide releasable attachment to the flat media;
a second longitudinal strut having opposed free ends, and having a pair of legs spaced apart along the length of the second longitudinal strut, each of the pair of legs configured to provide releasable attachment to the flat media, the second longitudinal strut being laterally spaced from the first longitudinal strut with the alignment frame being located between the first longitudinal strut and the second longitudinal strut;
a first lateral strut slidably connected to each of the first longitudinal strut and the second longitudinal strut, the first lateral strut being slidably connected to the alignment frame at two spaced locations; and
a second lateral strut slidably connected to each of the first longitudinal strut and the second longitudinal strut, the second lateral strut being longitudinally spaced from the first lateral strut, the second lateral strut being slidably connected to the alignment frame at two spaced locations.

14. The portable large format inkjet printer of claim 13, comprising at least one alignment panel mounted to the alignment frame, each respective alignment panel having an alignment indicia located at a fixed position within the field of view of the open interior window and configured to facilitate accurate manual positioning of the portable large format inkjet printer at a desired printing position at the media print area when the alignment frame is slidably moved with respect to the vertical printing adapter.

15. The portable large format inkjet printer of claim 14, wherein the at least one alignment panel is one of a plurality of alignment panels that are mounted to the alignment frame, wherein each alignment panel of the plurality of alignment panels is transparent and has at least one alignment indicia located at a respective fixed position within the field of view of the open interior window.

16. The portable large format inkjet printer of claim 14, wherein at least one alignment panel comprises a single alignment panel mounted to the alignment frame that covers an entirety of the open interior window of the alignment frame, the single alignment panel being transparent and having at least two alignment indicia located within the field of view of the open interior window.

17. The portable large format inkjet printer of claim 13, wherein the orthogonal directions have a first direction orthogonal to a second direction, the printhead carrier system configured to define a first printing extent in the first direction and a second printing extent in the second direction, wherein the dimensions of the first printing extent and the second printing extent define a resident print area of the portable large format inkjet printer, and
wherein the controller executes program instructions to process image data to print the image at the media print area, and if the resident print area is smaller than the media print area, then the controller configured to execute program instructions to divide the media print area and corresponding image data into a plurality of sectional print zone grids, and to control operation of the inkjet print engine to print in sequence a respective image portion of the image at each sectional print zone grid of the plurality of sectional print zone grids, after the portable large format inkjet printer is manually positioned and aligned, respectively, at each sectional print zone grid of the media print area.

18. A method for printing an image at a media print area of a stationary flat media, comprising:
providing a portable large format inkjet printer having an inkjet print engine having a printhead carrier system that carries a plurality of inkjet printheads over the media print area in each of two orthogonal directions during the printing of the image, having an alignment frame having an open interior window within which the plurality of inkjet printheads are moved and from which all printing occurs, and having at least one alignment panel mounted to the alignment frame, each respective alignment panel having an alignment indicia located within a field of view of the open interior window;
providing a mark on the stationary flat media to identify a desired printing position at the media print area;
manually positioning the portable large format inkjet printer to align the alignment indicia with the mark on the stationary flat media; and
operating the portable large format inkjet printer to print at least a portion of the image at the media print area of the stationary flat media.

19. The method of claim 18, wherein the mark is at least one edge of a previously printed image portion and the act of manually positioning comprises aligning the alignment indicia with the at least one edge of the previously printed image portion.

20. The method of claim 18, comprising:
dividing the media print area into a plurality of sectional print zone grids;
physically marking the media print area with grid marks that correspond to the plurality of sectional print zone grids;
the act of manually positioning comprises sequentially aligning the portable large format inkjet printer at each sectional print zone grid of the plurality of sectional print zone grids; and
the act of operating the portable large format inkjet printer comprises individually printing an image portion of the image at each sectional print zone grid that forms the media print area.
